(19) United States
(12) Patent Application Publication
(10) Pub. No.: US 2008/0302143 A1
(43) Pub. Date: Dec. 11, 2008

(54) Secure Tap

(76) Inventor: Orlando Eddie Clark, Kenner, LA (US)

Correspondence Address: ORLANDO E. CLARK, 840 JOE YENNIE BLVD. APT # 29, KENNER, LA, 70065, US

(21) Appl. No.: 11/760,716

(22) Filed: Jun. 8, 2007

(51) Int. Cl. E05B 65/00

(52) U.S. Cl. 70/57

(57) ABSTRACT

My invention “Secure Tap” is a locking box designed to fit over the tap that cable companies use to distribute their services to their customers. The purpose or use for this invention is to stop the theft of cable service and protect cable provider customers of services being interrupted by theft. The secure tap has internal hinge placement to avoid tampering with the hinge to gain unlawfully entry, also the lock placement is out of reach with a double locking latch. Meaning if the box is pried or forced open it will not lock or close therefore revealing the theft of service.

The Secure Tap is a housing or locking box to prevent the theft (stealing) of cable service from the tap. The Secure Tap is solely designed to enclose the tap and ports with openings on both sides for coaxial line exit and entry points. The tap is normally suspended between telephone and or light poles; the cable tap is where the cable company accesses their signal and installs a coaxial line to a resident or a business to receive service. The Secure Tap has the hinge placed on the inside of the box to avoid gaining false entry by tampering with hinge pins. The box has a double locking latch in the front that takes a key. If the secure tap is pried or forced open the box will not lock thus revealing that theft has taken place.

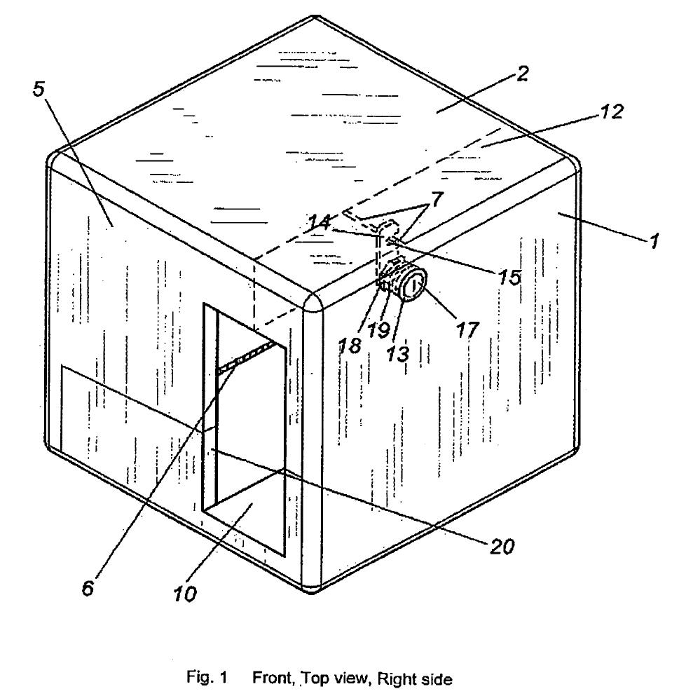

FIG. 1 shows the front top and right side view and openings on the right side for the entry and or exit of cable lines.

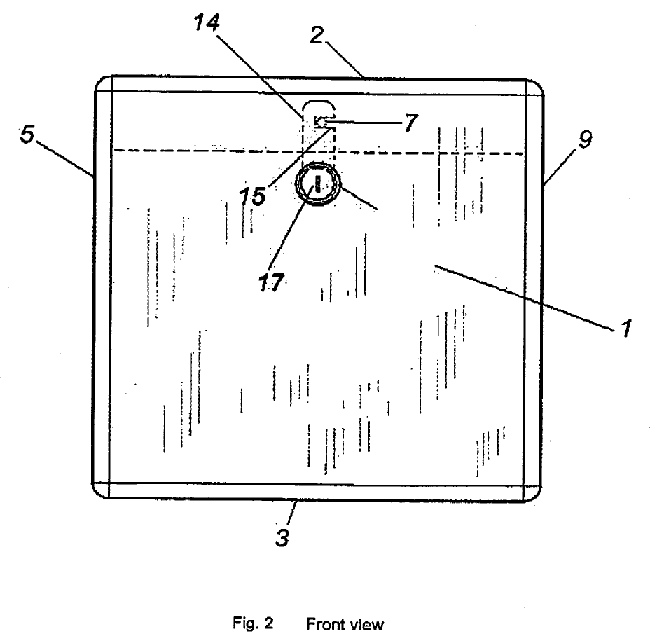

FIG. 2 shows the front view of the secure tap unit which is a square shaped box with circular opening to add lock to the front towards the top.

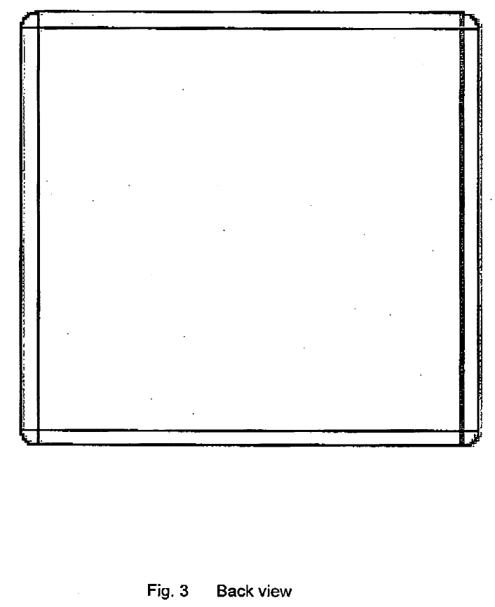

FIG. 3 shows the back view of the secure tap unit.

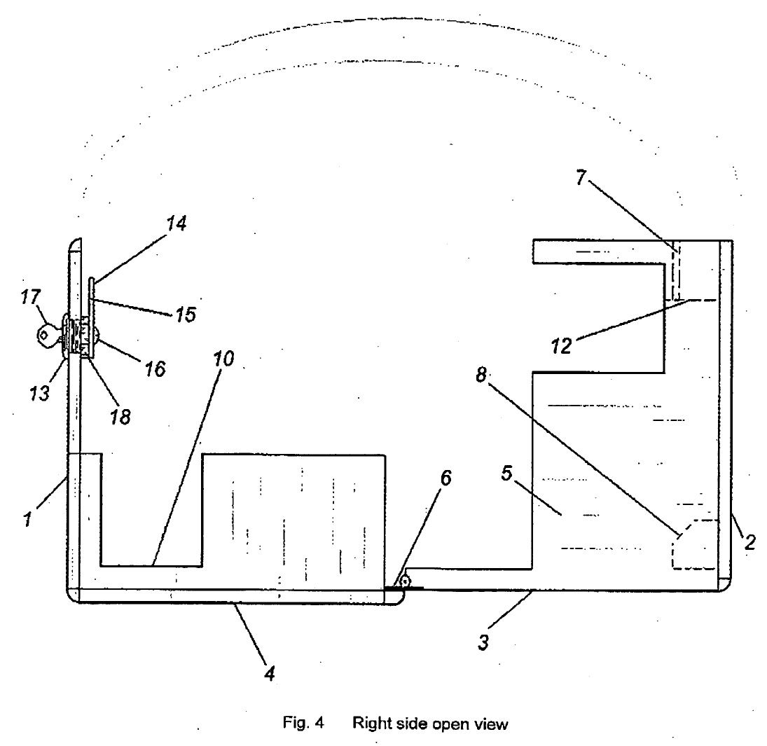

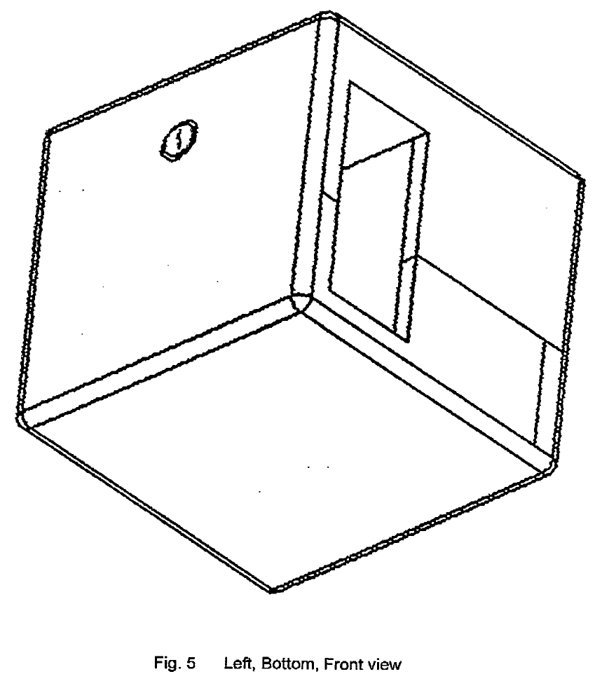

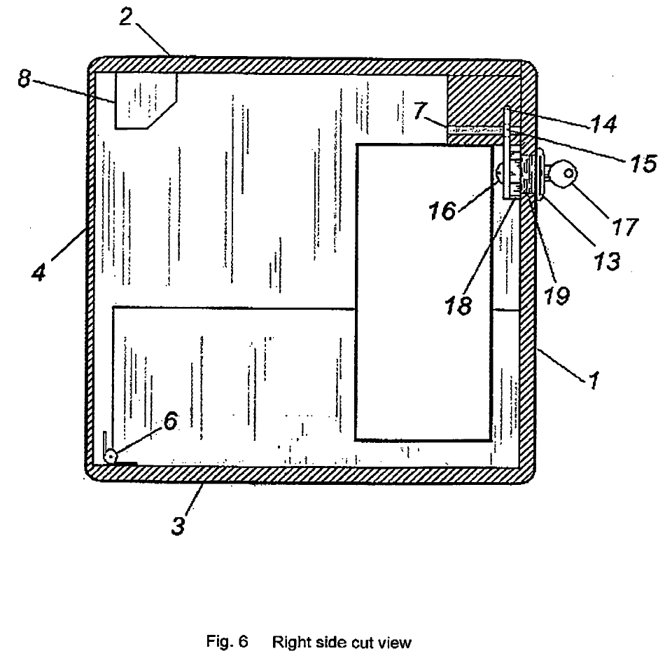

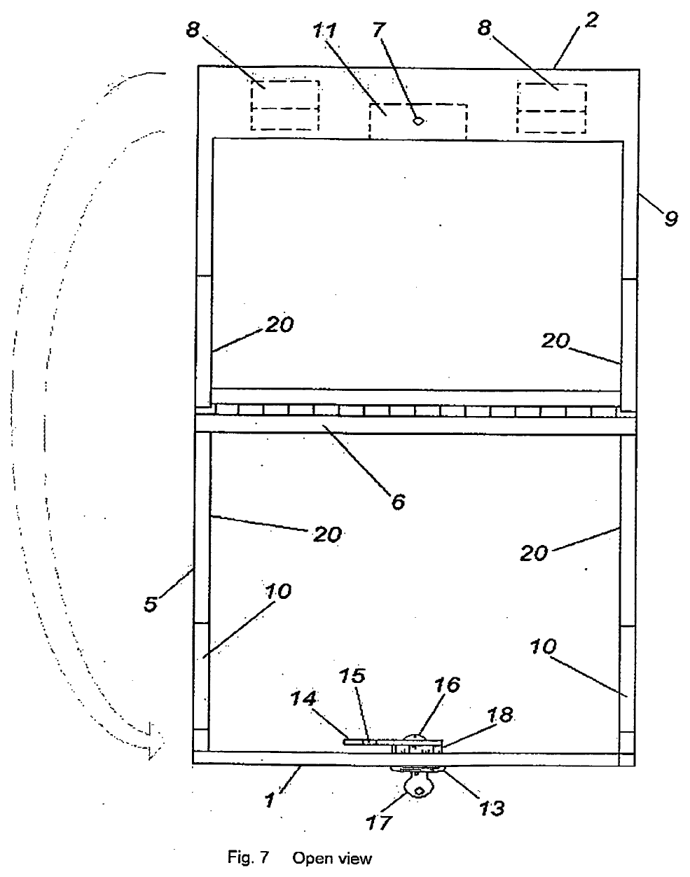

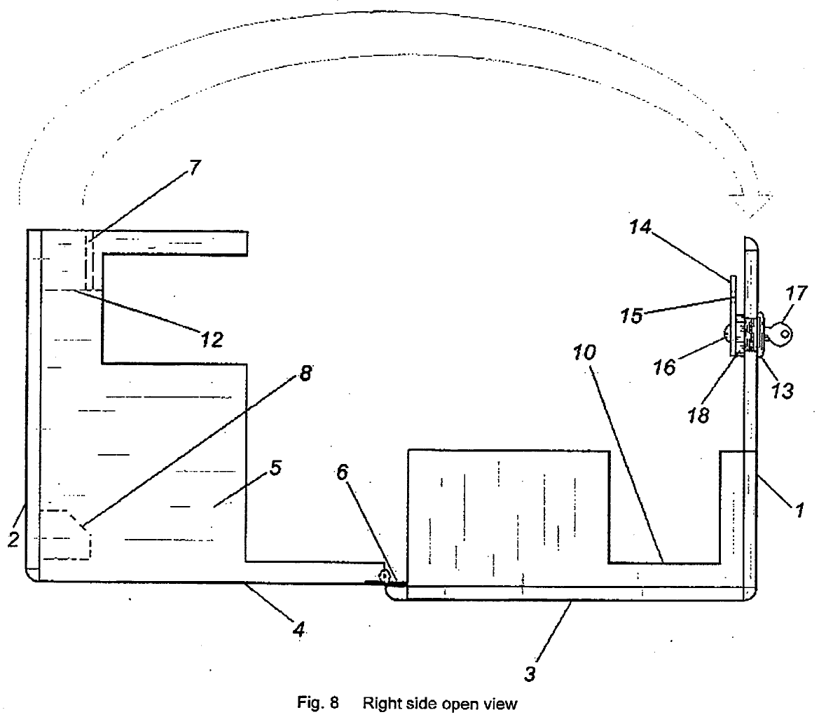

FIG. 4 shows the right side view with the openings for the entry and or exit of cable lines.

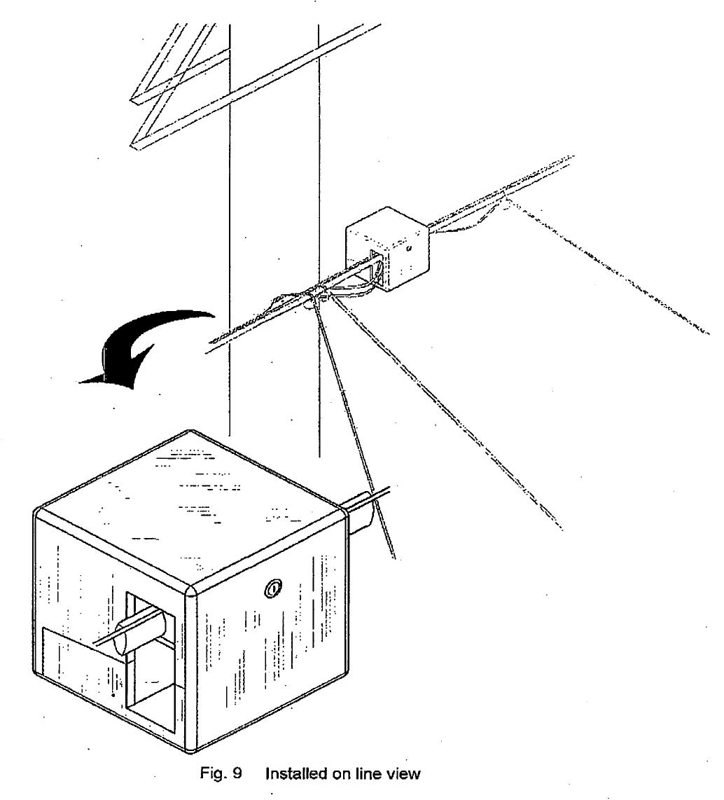

FIG. 5 shows the left bottom and front view of the secure tap with the opening on the left side for the entry and or exit of cable lines. The front view of the secure tap has an opening to add a lock to the front towards the top.

What is claimed is:

1. I claim that the locking device is an apparatus that is to be placed over the cable tap and locked without using any tools to prevent the theft of service or cable signal, the apparatus is in the shape of a square box with openings on both the left and the right side to allow the exit of coaxial cable wire.

2. A locking device according to claim 1 to be placed over the cable means to be affixed to the main coaxial line or feeder line with a locking apparatus over the tap, distribution box or cable signal outlet; this locking mechanism takes a key which comprises a dual lock, the locking apparatus is placed there to prevent the theft of service including 2 said openings on either side of the enclosure for the entry or exit of the coaxial cable.

3. A locking apparatus in accordance with claim 2 wherein the means for locking the front cover plate in its locked or closed position comprises a key activated lock in said front door, with said lock having a double locking latch that connects to a keeper on said inside top of locking apparatus and retains the front door in its closed position.

4. The locking apparatus according to claim 2 are placed over the tap and locked with openings on either side, wherein the said openings are needed to provide service from the tap to the customer, the said openings are positioned on the left and right side of the apparatus between the front and back door of the locking mechanism.

5. The locking apparatus according to claim 2 is place over the tap this is possible because of the hinge placement inside of the apparatus; the binge is placed in the backside of the apparatus along the bottom thus allowing it to open fully to gain access to said cable tap and wires.

6. A locking apparatus according to claim 5 the locking device can be opened fully to due to the hinge placement to gain access to the cable wires, once open the apparatus can be removed or detached from the main line without the use of any tools;
wherein the apparatus is simply placed over the tap and locked with only the coaxial wires exposed not the connections to the tap in order to prevent theft of service.

7. A locking device in accordance with claim 4, wherein there two said openings on each sides of the locking device, with the top and bottom grooves being in alignment with each other to form said opening when the locking apparatus is in the closed position.
